(19) United States
(12) Patent Application Publication
(10) Pub. No.: US 2007/0204093 A1
(43) Pub. Date: Aug. 30, 2007

(54) UPDATE DEVICE FOR USB TO RS232 ADAPTER

(75) Inventor: CHIA-HUNG WANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/563,147

(22) Filed: Nov. 25, 2006

(30) Foreign Application Priority Data
Feb. 28, 2006 (CN) 200610034071.9

(51) Int. Cl. G06F 13/36

(52) U.S. Cl. 710/315; 710/314

(57) ABSTRACT

An exemplary device for USB to RS232 adapter includes a computer with a code update software stored therein, a connector, and a voltage converter coupled to the connector. The computer is configured to connect to one end of the USB to RS232 adapter. The connector is configured to connect to an opposite end of the USB to RS232 adapter for receiving a low voltage signal from the computer via the RS232 adapter. The voltage converter is for receiving the low voltage signal and converting the low voltage signal to a high voltage signal to be transmitted to the computer via the connector and the USB to RS232 adapter, so that the computer starts the code update software to update the USB to RS232 adapter.

### BACKGROUND OF THE INVENTION

1. Field of the Invention

The present invention relates to an update device, and particularly to an update device for a USB to RS232 adapter.

2. Description of Related Art

With the rapid development of communication technologies, the Electronic Industries Alliance (EIA) and the Telecommunications Industry Association (TIA) have developed a series of standards to simplify data communication. RS232 is well known in the art, which has been a standard feature for serial communications. A DB9 connector is often used between devices supporting the RS232 standard. The RS232 standard remained in widespread use into the late 1990s, but has largely been supplanted by other interface standards in computer products, such as USB (Universal Serial Bus) standard. A USB to RS232 adapter is required for converting signals between the USB interface and the RS232 interface. However, the USB to RS232 adapter has no simple update function for programming changes in standards. A conventional solution to update the USB to RS232 adapter, is to remove an IC chip in the adapter and program updates in the IC chip, then reinstall the IC chip in the adapter. This is unduly laborious and expensive.

What is needed is to provide an update device for a USB to RS232 adapter, which has reduced cost, and simplicity of operation.

### SUMMARY OF THE INVENTION

An exemplary An update device for USB to RS232 adapter includes a computer with a code update software stored therein, a connector, and a voltage converter coupled to the connector. The computer is configured to connect to one end of the USB to RS232 adapter. The connector is configured to connect to an opposite end of the USB to RS232 adapter for receiving a low voltage signal from the computer via the RS232 adapter. The voltage converter is for receiving the low voltage signal and converting the low voltage signal to a high voltage signal to be transmitted to the computer via the connector and the USB to RS232 adapter, so that in the computer starts the code update software to update the USB to RS232 adapter.

Other advantages and novel features of the invention will become more apparent from the following detailed description when taken in conjunction with the accompanying drawing, in which:

### BRIEF DESCRIPTION OF THE DRAWINGS

FIG. 1 is a circuit diagram of a controller of an update device for a USB to RS232 adapter in accordance with a preferred embodiment of the present invention; and

FIG. 2 is a block diagram of the update device for a USB to RS232 adapter, together with a USB to RS232 adapter.

### DETAILED DESCRIPTION OF THE INVENTION

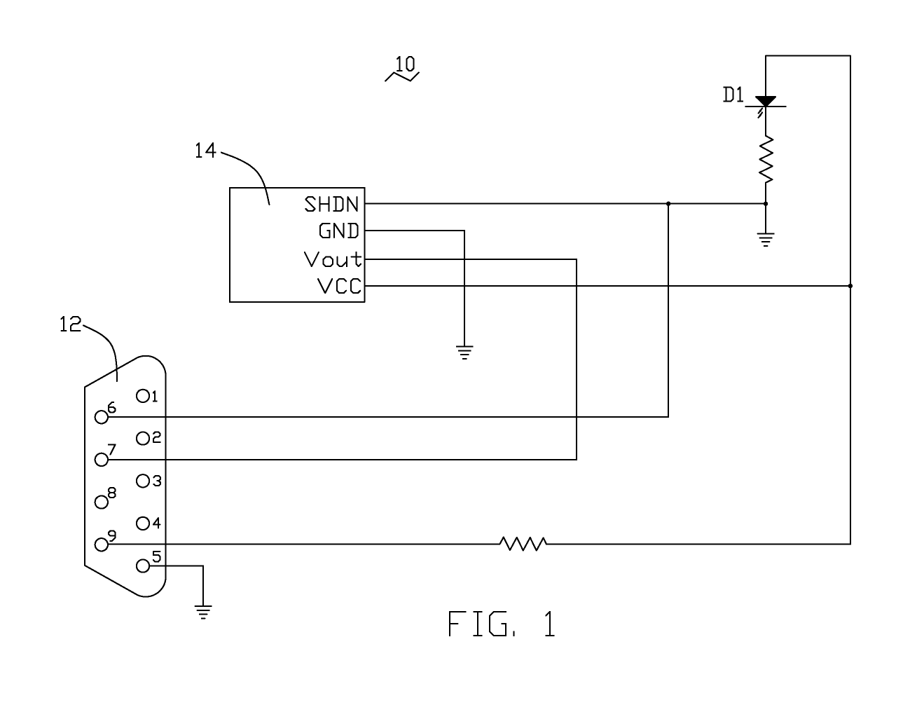

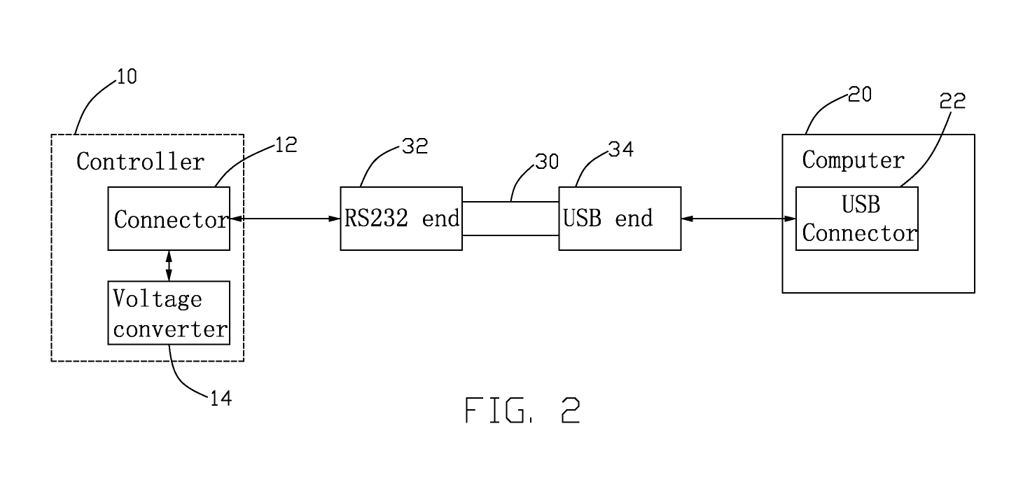

Referring to the FIGS. 1 and 2, an update device for a USB to RS232 adapter in accordance with a preferred embodiment of the present invention includes a computer 20 with a code update software stored therein, and a controller 10. The controller 10 includes a connector 12, and a voltage converter 14 electrically connected to the connector 12.

The connector 12 is a DB9 connector, and includes a plurality of signal pins 14, 6, 7, and 8, a power pin 9, and a GND pin 5. In the preferred embodiment of the present invention, the pins 6 and 7 are selected to transmit signals. The voltage converter 14 is an LTC1262 chipset which is a regulated DC/DC converter. The voltage converter 14 includes a VCC pin, a Vout pin, a GND pin, and a SHDN pin. The Vout pin of the voltage converter 14 is coupled to the signal pin 7 of the connector 12, and the SHDN pin of the voltage converter 14 is coupled to the signal pin 6 of the connector 12, and to ground. The VCC pin of the voltage converter 14 is coupled to the power pin 9 of the connector 12, the GND pin of the voltage converter 14 is grounded, the GND pin 5 of the connector 12 is grounded, and the power pin 9 of the connector 12 is grounded via a light-emitting diode (LED) D1.

In use, the connector 12 of the controller 10 is connected to an RS232 end 32 of a USB to RS232 adapter 30, which needs to be updated, and a USB end 34 of the USB to RS232 adapter 30 is connected to a USB connector 22 of the computer 20. Because the pin 6 of the connector 12 is grounded, a low level signal is generated at the signal pin 6, and is provided to a CPU of the computer 20 via the USB to RS232 adapter 30, and the CPU enters an update mode. The power pin 9 of the connector 12 receives a 5V voltage through the USB to RS232 adapter 30 from the USB connector 22 of the computer 20, and the LED D1 emits light to indicate that the CPU has entered the update mode. The 5V voltage is applied to the VCC pin of the voltage converter 14, the voltage converter 14 converts the 5V voltage to a 12V voltage and outputs the 12V voltage at the Vout pin. The 12V voltage is applied to the computer via the signal pin 7 and the USB to RS232 adapter 30, and the CPU receives the 12V voltage and starts the update code software to update the USB to RS232 adapter 30.

The signal pins of the connector 12 selected to transmit signals are not limited to pins 6 and 7, the signal pins 2 and 3 can also be selected to transmit signals. In use, the VCC pin, the Vout pin and the SHDN pin of the voltage converter 14 are connected to pins 5, 3, and 2 of the connector 12 respectively, and the pin 9 of the connector 12 and the GND pin of the voltage converter 14 are coupled to ground.

The controller 10 is connected to the CPU of the computer 20 via the USB to RS232 adapter 30, and receives the 5V voltage from the computer, converts the 5V voltage to the 12V voltage, and applies the 12V voltage to the CPU via the USB to RS232 adapter 30 to start the update code software stored in the computer 20 to update the USB to RS232 adapter 30. The update device has a simple structure and low cost, and facilitates updating the USB to RS232 adapter when changes in standards require it.

It is believed that the present embodiments and their advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. An update device for a USB to RS232 adapter, comprising:
a computer with a code update software stored therein, configured to connect to one end of the USB to RS232 adapter;
a connector configured to connect to an opposite end of the USB to RS232 adapter for receiving a low voltage signal from the computer via the RS232 adapter; and
a voltage converter coupled to the connector for receiving the low voltage signal, and converting the low voltage signal to a high voltage signal to be transmitted to the computer via the connector and the USB to RS232 adapter so that results in the computer starts the code update software to update the USB to RS232 adapter.

2. The update device as claimed in claim 1, wherein the low voltage signal is a 5V voltage signal, the high voltage signal is a 12V voltage signal, and the voltage converter is a 5V to 12V voltage converter.

3. The update device as claimed in claim 2, wherein the connector comprises two signal pins and a power pin, the voltage converter comprises a power pin, an output pin, and a state pin, the output pin and the state pin of the voltage converter are coupled to the two signal pins of the connector respectively, the state pin is grounded, and the power pin of the connector is connected to the power pin of the voltage converter.

4. The update device as claimed in claim 3, wherein the voltage converter has a ground pin connected to ground.

5. The update device as claimed in claim 3, further comprising a light-emitting diode (LED) connected between the power pin of the connector and ground.

6. A method for updating a USB to RS232 adapter which has a RS232 connector at one end thereof connected to a controller and a USB end at an opposite end thereof connected to a computer with a code update software stored therein, the method comprising the steps of:
sending a low voltage signal from the computer to the controller through the USB to RS232 adapter;
converting the low voltage signal to a high voltage signal;
sending the high voltage signal from the controller to the computer via the USB to RS232 adapter; and
running the code update software to update the USB to RS232 adapter.

7. The method as claimed in claim 6, wherein the controller comprises a connector configured to connect to the RS232 end, and a voltage converter coupled to the connector and configured for converting the low voltage signal to the high voltage signal.

8. A controller adapted for updating an electronic device with a program IC chip, the electronic device connecting to a computer with a code update software stored therein, the controller comprising:
a connector configured to connect to the electronic device, the connector comprising two signal pins, a power pin, and a ground pin being grounded; and
a voltage converter coupled to the connector, comprising a power pin connected to the power pin of the connector for receiving a low voltage signal from the computer to be converted to a high voltage signal, an output pin connected to one of the two signal pins of the connector, for outputting the high voltage signal to the computer via the electronic device to start the code update software to update the IC chip, a state pin connected to the other signal pin of the connector, and a ground pin being grounded.

9. The controller as claimed in claim 8, further comprising a light-emitting diode (LED) connected between the power pin of the connector and ground.
